(19) United States
(12) Patent Application Publication
(10) Pub. No.: US 2024/0405807 A1
(43) Pub. Date: Dec. 5, 2024

(54) SYSTEMS AND METHODS FOR BEAM SPOT ALIGNMENT ON RECONFIGURABLE INTELLIGENT SURFACE IN COMMUNICATION SYSTEMS

(71) Applicant: Huawei Technologies Co., Ltd., Shenzhen (CN)

(72) Inventors: Ahmad Abu Al Haija, Ottawa (CA); Mostafa Medra, Kanata (CA); Mohammadhadi Baligh, Ottawa (CA)

(21) Appl. No.: 18/776,446

(22) Filed: Jul. 18, 2024

Related U.S. Application Data
(63) Continuation of application No. PCT/CN2022/073275, filed on Jan. 21, 2022.

(51) Int. Cl. H04B 7/04; H04B 17/20

(52) U.S. Cl. CPC H04B 7/04013; H04B 17/252

(57) ABSTRACT

Aspects of the disclosure include configuring beams of a transmitter and a receiver so that the beam spots from the different nodes overlap, such that the received signals of one or more nodes satisfy a service requirement such as rate value, a gain value or a SNR value, at a reconfigurable intelligent surface (RIS) that is used to redirect a signal between the different nodes. Examples of the transmitter and the receiver may be a base station and one or more user equipment (UE) in a downlink or uplink direction or between two UEs in a sidelink direction. Another aspect of the disclosure is providing control signaling in order to configure the overlapping area of the beam spots. For example, signaling information pertaining to one or more beam parameters is exchanged between the transmitter and the receiver in order to facilitate the beamforming that is performed at each device.

### CROSS REFERENCE

This application is a continuation of International Application No. PCT/CN2022/073275, filed on Jan. 21, 2022, the disclosure of which is hereby incorporated by reference in its entirety.

### TECHNICAL FIELD

The present disclosure relates generally to wireless communications, and in particular embodiments, use of reconfigurable intelligent surfaces (RIS) in communication systems.

### BACKGROUND

In some wireless communication systems, user equipments (UEs) wirelessly communicate with a base station (for example, NodeB, evolved NodeB or gNB) to send data to the base station and/or receive data from the base station. A wireless communication from a UE to a base station is referred to as an uplink (UL) communication. A wireless communication from a base station to a UE is referred to as a downlink (DL) communication. A wireless communication from a first UE to a second UE is referred to as a sidelink (SL) communication or device-to-device (D2D) communication.

Resources are required to perform uplink, downlink and sidelink communications. For example, a base station may wirelessly transmit data, such as a transport block (TB), to a UE in a downlink transmission at a particular frequency and over a particular duration of time. The frequency and time duration used are examples of resources.

Metasurfaces have been investigated in optical systems for some time and recently have attracted interest in wireless communication systems. These metasurfaces are capable of affecting a wavefront that impinges upon them. Some types of these metasurfaces are controllable, meaning through changing the electromagnetic properties of the surface, the properties of the surface can be changed. For example, manipulation of the amplitude and/or phase can be achieved by changing an impedance or relative permittivity (and/or permeability) of the metamaterial. An example of a metasurface is a reconfigurable intelligent surface (RIS).

As a result, a controllable RIS can affect the environment and effective channel coefficients of a channel of which the RIS is a part thereof. This results in the channel being represented as the combination of an incoming wireless channel and an outgoing wireless channel and the phase/amplitude response of the configurable RIS.

Using these RISs in wireless communication systems will necessitate methods for using them in the wireless network from deploying the RIS to enabling them to work with other devices in the network.

### SUMMARY

Aspects of the disclosure include configuring beams of a transmitter and a receiver so that the beam spots from the different nodes overlap as much as possible at a reconfigurable intelligent surface (RIS) that is used to redirect a signal between the different nodes. Examples of the transmitter and the receiver may be a base station and one or more user equipment (UE) in a downlink or uplink direction or between two UEs in a sidelink direction. Another aspect of the disclosure is providing control signaling in order to optimize the overlapping area of the beam spots. For example, signaling information pertaining to one or more beam parameters is exchanged between the transmitter and the receiver in order to facilitate the beamforming that is performed at each device. The control signaling may also involve signaling between the transmitter and the RIS and/or between the receiver and the RIS to configure the RIS to activate particular portions of the RIS to redirect the beam between the transmitter and receiver.

According to an aspect, there is provided a method involving: receiving, by a user equipment (UE), first configuration information, the first configuration information comprising information for improved overlap of a beam spot of a beam of a base station (BS) and a beam spot of a beam of the UE both impinging on a reconfigurable intelligent surface (RIS) for transmitting or receiving signals between the base station and the UE; and reconfiguring the UE based on the first configuration information.

In some embodiments, the method further involves: receiving, by the UE, second configuration information, the second configuration information comprising identification of a plurality of beams, each beam having an associated direction, and identification of reference signals (RSs) on the plurality of beams; receiving, by the UE, the RSs on the plurality of beams; measuring, by the UE, the RSs to determine an angle of arrival (AoA) of the RSs at the UE; and transmitting, by the UE, measurement feedback information, the measurement feedback information comprising measurement information pertaining to a channel on a link between the base station and the UE via redirection by the RIS or a channel on a link between the RIS and the UE.

In some embodiments, the measurement feedback information comprises one or more of: measurement information based on measurements made at the UE; or an AoA of one or more RS at the UE with respect to a reference point or direction.

In some embodiments, the method further involves the UE receiving data that has been redirected by the RIS or transmitting data to be redirected by the RIS based on the second configuration information.

In some embodiments, the method further involves transmitting at least one of: UE location information; a number of antennas used by the UE; an antenna array patterns of the UE; a shape of a UE beam impinging on the RIS; beamwidth of a transmit beam or a receive beam of the UE; or an orientation of UE with respect to a reference point.

In some embodiments, the first configuration information comprises one or more of: an AoA for a UE receive beam with respect to a reference point or direction that is determined by the base station; beamwidth of a transmit beam or a receive beam of the UE; a size of the RIS; a location of an overlapping beam spot on the RIS; or a size of an overlapping beam spot on the RIS.

In some embodiments, the first configuration information comprises configuration information that enables the UE to interact with the base station by identifying: a portion of the RIS that is used for broadcast communication with at least two different UEs; or different portions of the RIS that are used for UE specific communication with each of multiple UEs.

In some embodiments, the method further involves: receiving, by the UE, third configuration information, the third configuration information comprising information for improved overlap of a beam spot of a beam of the UE and a beam spot of a beam of a second UE both impinging on the RIS for transmitting or receiving signals between the UE and the second UE; and reconfiguring the UE based on the third configuration information.

In some embodiments, the method further involves: transmitting, by the UE, fourth configuration information, the fourth configuration information comprising identification of a plurality of beams, each beam having an associated direction, and identification of RSs on the plurality of beams; transmitting, by the UE, the RSs on the plurality of beams; receiving, by the UE, measurement feedback information, the measurement feedback information comprising measurement information pertaining to a channel on a link between the UE and a second UE via redirection by the RIS; transmitting measurement feedback information to the base station; receiving, by UE, fifth configuration information, the fifth configuration information comprising information for improved overlap of a beam spot of a beam of the UE and a beam spot of a beam of the second UE both impinging on the RIS for transmitting or receiving signals between the UE and the second UE; and reconfiguring the UE based on the fifth configuration information.

In some embodiments, the method further involves receiving, by the UE, information from the RIS pertaining to a size of the beam spot of the beam of the UE or a size of the beam spot of the beam of the base station.

In some embodiments, the method further involves: receiving, by the UE, second configuration information, the second configuration information comprising identification of a plurality of beams, each beam having an associated direction, and identification of RSs on the plurality of beams; and transmitting, by the base station, the RSs on the plurality of beams.

In some embodiments, the method further involves: receiving, by the UE, updated configuration information determined at the base station based on the RSs on the plurality of beams.

In some embodiments, the updated configuration information comprises one or more of: an AoA of one or more RS at the base station with respect to a reference point or direction.

In some embodiments, the method further involves transmitting, by the UE, at least one of: UE location information; an angle of departure (AoD) at the UE that corresponds to the feedback measurements by the base station pertaining to a channel on a link between the base station and the UE via redirection by the RIS or a channel on a link between the RIS and the base station; a number of antennas used by the UE; an antenna array patterns of the UE; a shape of a UE beam impinging on the RIS; beamwidth of a transmit beam or a receive beam of the UE; or an orientation of UE with respect to a reference point.

In some embodiments, the first configuration information comprises one or more of an AoD for a UE transmit beam with respect to a reference point or direction that is determined by the base station; beamwidth of a transmit beam at the UE; a size of the RIS; a location of an overlapping beam spot on the RIS; or a size of an overlapping beam spot on the RIS.

According to an aspect, there is provided a device including a processor and a computer-readable medium. The computer readable medium having stored thereon, computer executable instructions, that when executed cause the processor to perform the method as described above.

According to an aspect, there is provided a method involving: transmitting, by a base station, first configuration information to a UE, the first configuration information comprising information relevant to the UE for improved overlap of a beam spot of a beam of the base station and a beam spot of a beam of the UE impinging on a RIS; and transmitting, by the base station, second configuration information, the second configuration information comprising configuration information relevant to the RIS for improved overlap of the beam spot of the base station and the beam spot of the UE on the RIS.

In some embodiments, the method further involves transmitting, by the base station, data that is redirected by the RIS or transmitting data to be redirected by the RIS based on the first configuration information and second configuration information.

In some embodiments, the method further involves: transmitting, by the base station, third configuration information, the third configuration information comprising identification of a plurality of beams, each beam having an associated direction, and identification of RSs on the plurality of beams; transmitting, by the base station, the RSs on the plurality of beams; receiving, by the base station, measurement feedback information, the measurement feedback information comprising measurement information pertaining to a channel on a link between the base station and the UE via redirection by the RIS or a channel on a link between the RIS and the base station; and determining, by the base station, revised configuration information for improved overlap of a beam spot of the base station and a beam spot of the UE on the RIS.

In some embodiments, the measurement feedback information comprises one or more of: measurement information based on measurements made at the UE; or an AoA of one or more RS at the UE with respect to a reference point or direction.

In some embodiments, the method further involves receiving at least one of: UE location information; a number of antennas used by the UE; an antenna array patterns of the UE; a shape of a UE beam impinging on the RIS; beamwidth of a transmit beam or a receive beam of the UE; or an orientation of UE with respect to a reference point.

In some embodiments, the first configuration information comprises one or more of: an AoA for a beam received at the UE with respect to a reference point or direction that is determined by the base station; beamwidth of a transmit beam or a receive beam of the UE; a size of the RIS; a location of an overlapping beam spot on the RIS; or a size of an overlapping beam spot on the RIS.

In some embodiments, the first configuration information comprises information that enables the BS to interact with multiple UEs by identifying: a portion of the RIS that is used for broadcast communication with at least two different UEs of the multiple UEs; or different portions of the RIS that are used for UE specific communication with each of the multiple UEs.

In some embodiments, the second configuration information comprises one or more of: an AoA for a beam received at the RIS that is determined by the base station; an AoD for a beam redirected by the RIS that is determined by the base station; a size of a region used by the RIS to redirect a beam; a location of an overlapping beam spot on the RIS; a size of an overlapping beam spot on the RIS; or RIS element phase information for redirecting a signal from the base station to the UE or from the UE to the base station.

In some embodiments, the second configuration information comprises configuration information that enables the base station to interact with multiple UEs by identifying: a portion of the RIS that is used for broadcast communication with at least two different UEs of the multiple UEs; or different portions of the RIS that are used for UE specific communication with each of the multiple UEs.

In some embodiments, the method further involves transmitting, by the base station, fourth configuration information, the fourth configuration information comprising information for improved overlap of a beam spot of a beam of the UE and a beam spot of a beam of a second UE both impinging on the RIS for transmitting or receiving signals between the UE and the second UE; and reconfiguring the UE based on the fourth configuration information.

In some embodiments, the method further involves receiving, by the base station, information from the RIS pertaining to a size of the beam spot of the beams of the UE or a size of the beam spot of the beam of the base station.

In some embodiments, the method further involves: transmitting, by the base station, second configuration information, the second configuration information comprising identification of a plurality of beams, each beam having an associated direction, and identification of RSs on the plurality of beams; receiving, by the base station, the RSs on the plurality of beams; measuring, by the base station, the RSs to determine an AoD of the RSs at the UE.

In some embodiments, the method further involves: transmitting, by the base station, updated configuration information based on the determined angle of AoD of the RSs at the UE.

In some embodiments, the updated configuration information comprises one or more of: an AoA of one or more RS at the base station with respect to a reference point or direction.

In some embodiments, the method further involves receiving, by the base station, at least one of: UE location information; an angle of departure (AoD) at the UE that corresponds to the feedback measurements by the base station pertaining to a channel on a link between the base station and the UE via redirection by the RIS or a channel on a link between the RIS and the base station; a number of antennas used by the UE; an antenna array patterns of the UE; a shape of a UE beam impinging on the RIS; beamwidth of a transmit beam or a receive beam of the UE; or an orientation of UE with respect to a reference point.

In some embodiments, the first configuration information comprises one or more of: an angle of departure (AoD) for a UE transmit beam with respect to a reference point or direction that is determined by the base station; beamwidth of a transmit beam at the UE; a size of the RIS; a location of an overlapping beam spot on the RIS; or a size of an overlapping beam spot on the RIS.

According to an aspect, there is provided a device including a processor and a computer-readable medium. The computer readable medium having stored thereon, computer executable instructions, that when executed cause the processor to perform the method as described above.

According to an aspect, there is provided a method involving: receiving, by a reconfigurable intelligent surface (RIS), first configuration information, the first configuration information comprising identification of a plurality of beams, each beam having an associated direction, and identification of reference signals (RSs) on the plurality of beams; redirecting, by the RIS, the RSs from a base station on the plurality of beams in a direction of a user equipment (UE); redirecting, by the RIS, measurement feedback information from the UE to the base station, the measurement feedback information comprising measurement information pertaining to a channel on a link between the base station and the UE via redirection by the RIS or a channel on a link between the RIS and the UE; receiving, by the RIS, second configuration information, the second configuration information comprising configuration information for improved overlap of a beam spot of a beam of the base station and a beam spot of a beam of the UE impinging on the RIS for transmitting or receiving signals.

In some embodiments, the second configuration information comprises one or more of: an angle of arrival (AoA) for a beam received at the RIS that is determined by the base station; an angle of departure (AoD) for a beam redirected by the RIS that is determined by the base station; a size of a region used by the RIS to redirect a beam; a location of an overlapping beam spot on the RIS; a size of an overlapping beam spot on the RIS; and RIS element phase information for redirecting a signal from the BS to the UE or from the UE to the base station.

In some embodiments, the second configuration information comprises configuration information that enables the base station to interact with one or more UE by identifying: a portion of the RIS that is used for broadcast communication with at least two different UEs; or different portions of the RIS that are used for UE specific communication with each of multiple UEs.

In some embodiments, the second configuration information comprises configuration information that enables a first UE to communicate with a second UE by identifying: a portion of the RIS that is used for side link communication between the first UE and the second UE.

In some embodiments, the method further involves, when the RIS has active elements capable of detecting a signal that impinges a surface of the RIS, the RIS transmitting information to at least one of the UE and the base station pertaining to a size of the beam spot of the beam of the UE or a size of the beam spot of the beam of the base station.

According to an aspect, there is provided a device including a processor and a computer-readable medium. The computer readable medium having stored thereon, computer executable instructions, that when executed cause the processor to perform the method as described above.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a transmission channel between a source and destination in which a planar array of configurable elements is used to redirect signals according to an aspect of the disclosure.

FIG. 2A is a schematic diagram of a communication system in which embodiments of the disclosure may occur.

FIG. 2B is another schematic diagram of a communication system in which embodiments of the disclosure may occur.

FIG. 3A is a block diagram illustrating units or modules in a device in which embodiments of the disclosure may occur.

FIG. 3B is a block diagram of an example reconfigurable intelligent surfaces (RIS).

FIG. 4 is a block diagram illustrating units or modules in a device in which embodiments of the disclosure may occur.

FIG. 5A is a schematic diagram of a portion of a network including a base station (BS), a RIS and a user equipment (UE).

FIG. 5B is a schematic diagram of a beam spot from a BS and a beam spot of a UE impinging on a portion of a RIS according to an aspect of the application.

FIGS. 6A, 6B and 6C are schematic diagrams of different factors that affect how a beam spot from a BS and a beam spot of a UE impinge on a portion of a RIS.

FIG. 7 is a schematic diagram showing features that enable a size of a beam spot to be determined when a beam spot from a device impinges on a portion of a RIS according to an aspect of the application.

FIG. 8 is a schematic diagram of an example of a beam spot from a BS and a beam spot of a UE impinging on a portion of a RIS that is used to determine beam parameters and a table identifying the parameters according to an aspect of the application.

FIG. 9A is a schematic diagram of an example of how a beam spot from a BS and a beam spot of a UE impinging on a portion of a RIS can be modified to substantially overlap according to an aspect of the application.

FIG. 9B is a schematic diagram of another example of how a beam spot from a BS and a beam spot of a UE impinging on a portion of a RIS can be modified to substantially overlap according to an aspect of the application.

FIG. 10 is an example of a signaling flow diagram for signaling between a base station, a UE, and a RIS according to an aspect of the present disclosure.

FIGS. 11A, 11B and 11C are schematic diagrams for multiple node communication scenarios according to aspects of the present disclosure.

FIG. 12 is another example of a signaling flow diagram for signaling between a base station, a UE, and a RIS according to an aspect of the present disclosure.

### DETAILED DESCRIPTION OF THE EMBODIMENTS

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

Controllable metasurfaces are referred to by different names such as reconfigurable intelligent surface (RIS), large intelligent surface (LIS), intelligent reflecting surface (IRS), digital controlled surface (DCS), intelligent passive mirrors, and artificial radio space. While in subsequent portions of this document RIS is used most frequently when referring to these metasurfaces, it is to be understood then this is for simplicity and is not indented to limit the disclosure.

A RIS can realize “smart radio environment” or “smart radio channel” i.e. the environment radio propagation properties can be controlled to realize personalized channel for desired communication. The RIS may be established among multiple base stations to produce large scale smart radio channels that serve multiple users. With a controllable environment, RISs may first sense environment information and then feeds the environment information that has been sensed back to the system. According to this information, the system may optimize transmission mode parameters and RIS parameters through smart radio channels, at one or more of the transmitter (whether the base station or a UE), the channel and the receiver (whether the UE or a base station).

Because of beamforming gains associated with RISs, exploiting smart radio channels may significantly improve one or more of link quality, system performance, cell coverage, and cell edge performance in wireless networks. Not all RIS panels use the same structure. Different RIS panels may be designed with different types of phase adjusting capabilities that range from continuous phase control, to discrete control with multiple levels.

Another application of RISs is in transmitters that directly modulate incident radio one or more wave properties, such as phase, amplitude polarization and/or frequency without a need for active components as used in RF chains in traditional multiple input multiple output (MIMO) transmitters. RIS based transmitters have many merits, such as simple hardware architecture, low hardware complexity, low energy consumption and high spectral efficiency. Therefore, RISs provide a new direction for extremely simple transmitter design in future radio systems.

RIS assisted MIMO also may be used to assist fast beamforming with the use of accurate positioning, or to conquer blockage effects through CSI acquisition in mmWave systems. Alternatively, RIS assisted MIMO may be used in non-orthogonal multiple access (NOMA) in order to improve reliability at very low signal to noise ratio (SNR), accommodate more users and enable higher modulation schemes. RIS is also applicable to native physical security transmission, wireless power transfer or simultaneous data and wireless power transfer, and flexible holographic radios.

The ability to control the environment and network topology through strategic deployment of RISs, and other non-terrestrial and controllable nodes is an important paradigm shift in MIMO system, such as 6G MIMO. Such controllability is in contrast to the traditional communication paradigm, where transmitters and receivers adapt their communication methods to achieve the capacity predicted by information theory for the given wireless channel. Instead, by controlling the environment and network topology, MIMO aims to be able to change the wireless channel and adapt the network condition to increase the network capacity.

One way to control the environment is to adapt the topology of the network as user distribution and traffic patterns change over time. This involves utilizing high altitude pseudo satellites (HAPs), unmanned ariel vehicles (UAVs) and drones when and where it is necessary.

RIS-assisted MIMO utilizes RISs to enhance the MIMO performance by creating a smart radio channel. To extract full potential of RIS-assisted MIMO, a system architecture and more efficient scheme are provided in the present disclosure.

An RIS may include many small reflection elements, often comparable in size with the wavelength (for example, from 1/10 to a couple of wavelengths). Each element can be controlled independently. The control mechanism may be, for example, a bias voltage or a driving current to change the characteristics of the element. The combination of the control voltages for all elements (and hence the effective response) may be referred to as the RIS pattern. This RIS pattern may control the behavior of the RIS including at least one of the width, shape and direction of the beam, which is referred to as the beam pattern.

The controlling mechanism of the RIS often is through controlling the phase of a wavefront incident on the surface and reflected by the surface. Other techniques of controlling the RIS include attenuating reflection of the amplitude to reduce the reflected power and “switching off” the surface. Attenuating the power and switching off the surface can be realized by using only a portion of the RIS, or none of the RIS, for reflection while applying a random pattern to the rest of the panel, or a pattern that reflects the incident wavefront in a direction that is not in a desired direction.

In some portions of this disclosure, RIS may be referred to as a set of configurable elements arranged in a linear array or a planar array. Nevertheless, the analysis and discussions are extendable to two or three dimensional arrangements (e.g., circular array). A linear array is a vector of N configurable elements and a planar array is a matrix of N×M configurable elements, where N and M are non-zero integers. These configurable elements have the ability to redirect a wave/signal that is incident on the linear or planar array by changing the phase of the wave/signal. The configurable elements are also capable of changing the amplitude, polarization, or even the frequency of the wave/signal. In some planar arrays these changes occur as a result of changing bias voltages that control the individual configurable elements of the array via a control circuit connected to the linear or planar array. The control circuit that enables control of the linear or planar array may be connected to a communications network that base stations and UEs communicating with each other are part of. For example, the network that controls the base station may also provide configuration information to the linear or planar array. Control methods other than bias voltage control include, but are not limited to, mechanical deformation and phase change materials.

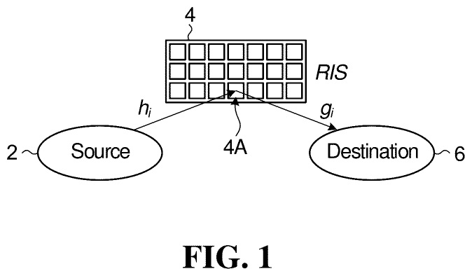

Because of their ability to manipulate the incident wave/signal, the low cost of these types of RIS, and because these types of RIS require small bias voltages, RIS have recently received heightened research interest in the area of wireless communication as a valuable tool for beamforming and/or modulating communication signals. A basic example for RIS utilization in beamforming is shown in FIG. 1 where each RIS configurable element 4a (unit cell) can change the phase of the incident wave from source such that the reflected waves from all of the RIS elements are aligned to the direction of the destination to increase or maximize its received signal strength (e.g. maximize the signal to noise ratio). Such a reflection via the RIS may be referred to as reflect-array beamforming. In some embodiments, the planar array of configurable elements, which may be referred to as an RIS panel, can be formed of multiple co-planar RIS sub-panels. In some embodiments, the RIS can be considered as an extension of the BS antennas or a type of distributed antenna. In some embodiments, the RIS can also be considered as a type of passive relay.

Aspects of the present disclosure provide methods and device for utilizing RIS panels in the wireless network to take advantage of the RIS capabilities, intelligence, coordination and speed, and thereby propose solutions having different signaling details and capability requirements.

FIG. 1 illustrates an example of a planar array of configurable elements, labelled in the figure as RIS 4, in a channel between a source 2, or transmitter, and a destination 6, or receiver. The channel between the source 2 and destination 6 include a channel between the source 2 and RIS 4 identified as h; and a channel between the RIS 4 and destination 6 identified as gᵢ for the i^{th} RIS configurable element (configurable element 4a) where i∈{1,2,3, . . . , N*M} assuming the RIS consists of N*M elements or unit cells. A wave that leaves the source 2 and arrives at the RIS 4 can be said to be arriving with a particular AoA. When the wave is reflected or redirected by the RIS 4, the wave can be considered to be leaving the RIS 4 with a particular AoD. In some embodiments, the planar array of configurable elements, which may be referred to as an RIS panel, can be formed of multiple co-planar RIS sub-panels. In some embodiments, the RIS can be considered as an extension of the BS antennas or a type of distributed antenna. In some embodiments, the RIS can also be considered as a type of passive relay.

While FIG. 1 has two dimensional planar array RIS 4 and shows a channel hi and a channel gᵢ, the figure does not explicitly show an elevation angle and azimuth angle of the transmission from the source 2 to RIS 4 and the elevation angle and azimuth angle of the redirected transmission from the RIS 4 to the destination 6. In the case of a linear array, there may be only one angle to be concerned about, i.e. the azimuth angle.

In wireless communications, the RIS 4 can be deployed as 1) a reflector between a transmitter and a receiver, as shown in FIG. 1, or as 2) a transmitter (integrated at the transmitter) to help implement a virtual MIMO system as the RIS helps to direct the signal from a feeding antenna.

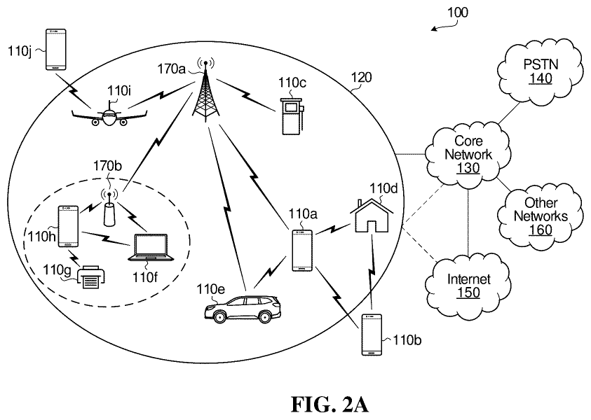

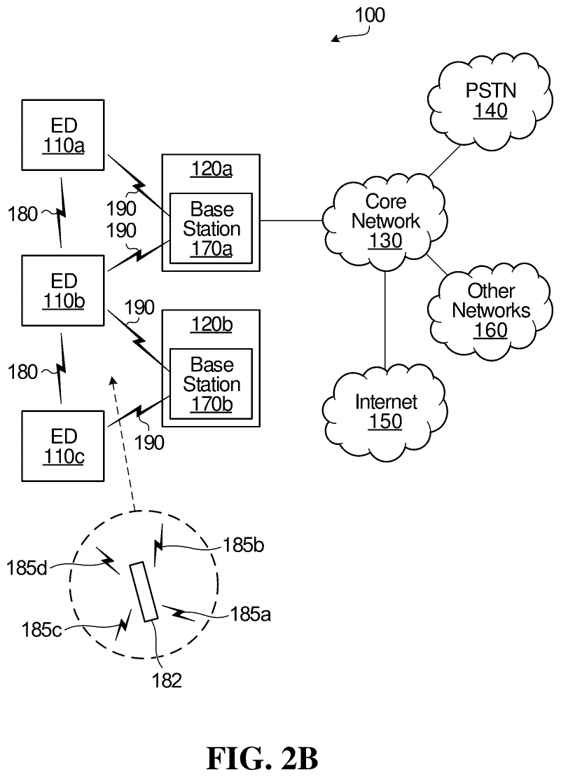

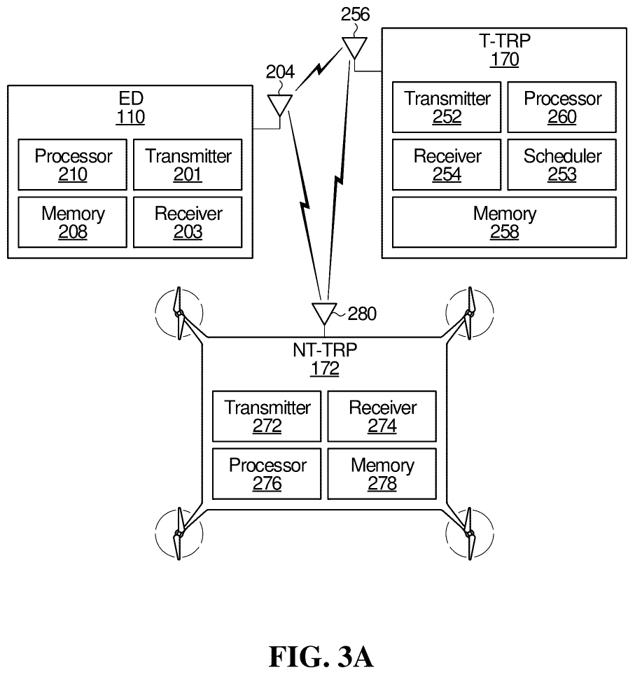

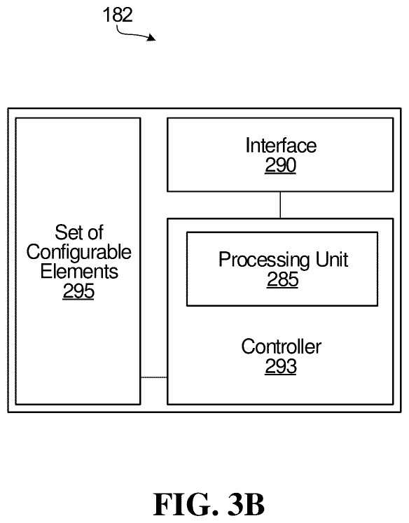

FIGS. 2A, 2B, 3A and 3B following below provide context for the network and device that may be in the network and that may implement aspects of the present disclosure.

Referring to FIG. 2A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

FIG. 2B illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 2B, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

FIG. 2B illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110c, radio access networks (RANs) 120a-120b, a core network 130, a public switched telephone network (PSTN) 140, the internet 150, and other networks 160. Although certain numbers of these components or elements are shown in FIG. 2B, any reasonable number of these components or elements may be included in the communication system 100.

The EDs 110a-110c are configured to operate, communicate, or both, in the communication system 100. For example, the EDs 110a-110c are configured to transmit, receive, or both, via wireless or wired communication channels. Each ED 110a-110c represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 2B, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 170a-170b may be a non-terrestrial base station that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110c may be alternatively or additionally configured to interface, access, or communicate with any other base station 170a-170b, the internet 150, the core network 130, the PSTN 140, the other networks 160, or any combination of the preceding.

The EDs 110a-110c and base stations 170a-170b are examples of communication equipment that can be configured to implement some or all of the operations and/or embodiments described herein. In the embodiment shown in FIG. 2B, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b communicate with one or more of the EDs 110a-110c over one or more air interfaces 190 using wireless communication links e.g. radio frequency (RF), microwave, infrared (IR), etc. The air interfaces 190 may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190.

A base station 170a-170b may implement Universal Mobile Telecommunication System (UMTS) Terrestrial Radio Access (UTRA) to establish an air interface 190 using wideband CDMA (WCDMA). In doing so, the base station 170a-170b may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b may establish an air interface 190 with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110c communicate with one another over one or more sidelink (SL) air interfaces 180 using wireless communication links e.g. radio frequency (RF), microwave, infrared (IR), etc. The SL air interfaces 180 may utilize any suitable radio access technology, and may be substantially similar to the air interfaces 190 over which the EDs 110a-110c communication with one or more of the base stations 170a-170c, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 180. In some embodiments, the SL air interfaces 180 may be, at least in part, implemented over unlicensed spectrum.

In addition, some or all of the EDs 110a-110c may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110c may be multimode devices capable of operation according to multiple radio access technologies, and incorporate multiple transceivers necessary to support multiple radio access technologies.

Also shown in FIG. 2B is a RIS 182 located within the serving area of base station 170b. A first signal 185a is shown between the base station 170b and the RIS 182 and a second signal 185b is shown between the RIS 182 and the ED 110b, illustrating how the RIS 182 might be located within the uplink or downlink channel between the base station 170b and the ED 110b. Also shown is a third signal 185c between the ED 110c and the RIS 182 and a fourth signal 185d is shown between the RIS 182 and the ED 110b, illustrating how the RIS 182 might be located within the SL channel between the ED 110c and the ED 110b.

While only one RIS 182 is shown in FIG. 2B, it is to be understood that any number of RIS could be included in a network.

In some embodiments, the signal is transmitted from a terrestrial BS to the UE or transmitted from the UE directly to the terrestrial BS and in both cases the signal is not reflected by a RIS. However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

FIG. 3A illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3A, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 2A or 2B). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 3A. FIG. 3A illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

While not shown in FIG. 3A, a RIS may be located between the ED 110 and the NT-TRP 172 or between the ED 110 and the T-TRP 170, in a similar manner as RIS 182 is shown between the EDs 110 and base station 170b in FIG. 2B. A RIS may be located between the NT-TRP 172 and the T-TRP 170 to aid in communication between the two TRPs.

Additional details regarding the EDs 110, T-TRP 170, and NT-TRP 172 are known to those of skill in the art. As such, these details are omitted here.

FIG. 3B illustrates an example RIS device that may implement the methods and teachings according to this disclosure. In particular, FIG. 3B illustrates an example RIS device 182. These components could be used in the system 100 shown in FIGS. 2A and 2B, the system shown in FIG. 3A, or in any other suitable system.

As shown in FIG. 3B, the RIS device 182, which may also be referred to as a RIS panel, includes a controller 293 that includes at least one processing unit 285, an interface 290, and a set of configurable elements 295. The set of configurable elements are arranged in a single row or a grid or more than one row, which collectively form the reflective surface of the RIS panel. The configurable elements can be individually addressed to alter the direction of a wavefront that impinges on each element. RIS reflection properties (such as beam direction, beam width, frequency shift, amplitude, and polarization) are controlled by RF wavefront manipulation that is controllable at the element level, for example via the bias voltage at each element to change the phase of the reflected wave. This control signal forms a pattern at the RIS. To change the RIS reflective or redirecting behavior, the RIS pattern needs to be changed.

Connections between the RIS and a UE can take several different forms. In some embodiments, the connection between the RIS and the UE is a reflective channel where a signal from the BS is reflected, or redirected, to the UE or a signal from the UE is reflected to the BS. In some embodiments, the connection between the RIS and the UE is a reflective connection with passive backscattering or modulation. In such embodiments a signal from the UE is reflected by the RIS, but the RIS modulates the signal by the use of a particular RIS patter. Likewise, a signal transmitted from the BS may be modulated by the RIS before it reaches the UE. In some embodiments, the connection between the RIS and the UE is a network controlled sidelink connection. This means that that the RIS may be perceived by the UE as another device like a UE, and the RIS forms a link similar to two UEs, which is scheduled by the network. In some embodiments, the connection between the RIS and the UE is an ad hoc in-band/out-of-band connection.

A RIS device, also referred to as a RIS panel, is generally considered to be the RIS and any electronics that may be used to control the configurable elements and hardware and/or software used to communication with other network nodes. However, the expressions RIS, RIS panel and RIS device may be used interchangeably in this disclosure to refer to the RIS device used in a communication system.

The processing unit 285 implements various processing operations of the RIS 182, such as receiving the configuration signal via interface 290 and providing the signal to the controller 293. The processing unit 285 could, for example, include a microprocessor, microcontroller, digital signal processor, field programmable gate array, or application specific integrated circuit.

While this is a particular example of an RIS, it should be understood that the RIS may take different forms and be implemented in different manner than shown in FIG. 3B. The RIS 182 ultimately needs a set of configurable elements that can be configured as described to operate herein.

FIG. 3B illustrates an interface 290 to receive configuration information from the network. In some embodiments, the interface 290 enables a wired connection to the network. The wired connection may be to a base station or some other network-side device. In some embodiments, the wired connection is a propriety link, i.e. a link that is specific to a particular vendor or supplier of the RIS equipment. In some embodiments, the wired connection is a standardized link, e.g. a link that is standardized such that anyone using the RIS uses the same signaling processes. The wired connection may be an optical fiber connection or metal cable connection.

In some embodiments, the interface 290 enables a wireless connection to the network. In some embodiments, the interface 290 may include a transceiver that enables RF communication with the BS or with the UE. In some embodiments, the wireless connection is an in-band propriety link. In some embodiments, the wireless connection is an in-band standardized link. The transceiver may operate out of band or using other types of radio access technology (RAT), such as Wi-Fi or BLUETOOTH. In some embodiments, the transceiver is used for low rate communication and/or control signaling with the base station. In some embodiments, the transceiver is an integrated transceiver such as an LTE, 5G, or 6G transceiver for low rate communication. In some embodiments, the interface could be used to connect a transceiver or sensor to the RIS.

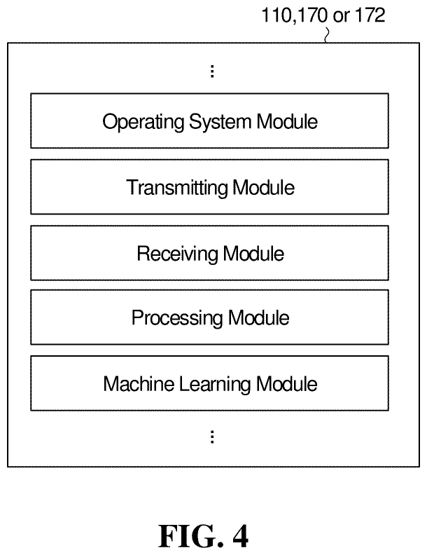

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent MCS, intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprise several frameworks, e.g., distributed machine learning and federated learning. AI/ML architectures comprises intelligent controller which can perform as single agent or multi-agent, based on joint optimization or individual optimization. New protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data-hungry. In order to involve AI/ML and sensing in wireless communications, more and more data are needed to be collected, stored, and exchanged. The characteristics of wireless data expand quite large ranges in multiple dimensions, e.g., from sub-6 GHZ, millimeter to Terahertz carrier frequency, from space, outdoor to indoor scenario, and from text, voice to video. These data collecting, processing and usage operations are performed in a unified framework or a different framework.

Aspects of the present disclosure are directed to communication that uses at least one RIS between at least two nodes (e.g. a transmitter and at least one receiver such as a base station and at least one UE. Aspects of the disclosure are directed in particular to when beam spots of communicating nodes do not substantially overlap at the RIS. Such a scenario may occur in near-field communication or may occur when the beams of different nodes do not cover the whole RIS. A region or portion of the RIS that is covered by a node's beam (either a transmitter or a receiver) can be defined as the beam spot (or a beam footprint) of that node at the RIS. A beam spot of a node at the RIS refers to a region or portion of the RIS that is covered by that node's beam (either a transmitter or a receiver) with sufficient gain/power that satisfies a certain value determined by one or more criteria. Examples of the one or more criteria, include, but are not limited to, the gain/power/SNR value not being less than a certain threshold from the peak value delivered to the RIS (e.g. the middle of the beam may have the peak gain/power) or the gain/power value being higher than a noise value by a certain threshold (i.e., the SNR from a node to any point in the beam spot satisfies a certain threshold.). Such a threshold may also apply if there are different beam spots for different nodes that are a part of different communication links.

Aspects of the disclosure provide a manner for configuring beams from different nodes such that the beams from the different nodes substantially align (overlap) at the RIS. When the beams substantially align, i.e. the beam spots align) this helps improve a total gain for a signal between the two nodes and efficiently utilize the RIS for multi-link communication, i.e. a link from a base station to the RIS and a link from the RIS to a UE.

In some embodiments, different portions of the RIS may be configured to help improve performance of multiple different communication links in the network.

Aspects of the present disclosure include methods for configuring beams at the transmitter and the receiver such that the beams are substantially overlapped at the RIS. Aspects of the present disclosure also include methods for signaling associated with the proposed beam configuration and RIS beam spot alignment.

When referring to a beam from a node not covering the whole RIS area, the RIS area of interest is the RIS area of relevant incident power. Theoretically, the beam may cover the whole RIS area, however, parts of that area may have a negligible amount of incident power. For example, if a beam illuminates the RIS where 99% of the power illuminates a small portion of the RIS, while the other 1% of the power illuminates the remainder of the RIS. In such a case, it would be advantageous to optimize the RIS elements of the area on which 99% of the power of the beam is incident with a beam spot of the other node beam to make the communication more efficient. The areas of the RIS that are covered by the remaining negligible amount of power do not affect the validity of the ideas presented herein. In some embodiments, the power considered to be relevant can be, for example, that which is not less than a certain value from a peak value; e.g., 10 dB, or that is higher than a noise level by a certain value; e.g., 3 dB. An area of the RIS that has an incident relevant power is what is intended by a beam spot on the RIS.

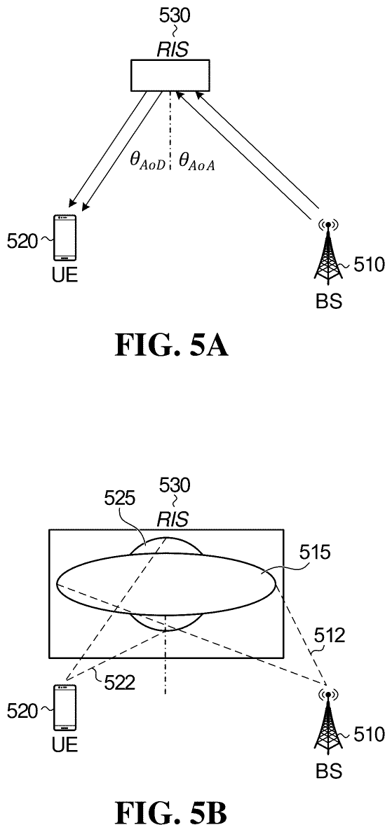

FIGS. 5A and 5B illustrate two different examples of communication between two nodes, wherein the communication also includes the use of a RIS. FIG. 5A illustrates a link between the two nodes, in particular a base station (BS) 510 and UE 520, that are communicating via a RIS 530. In this example, the beams of the BS 510 and the UE 520 each cover the entire RIS 530. This may be considered to be a far field communication scenario. In such a scenario the RIS 530 may have a small size and the beams of the BS 510 and/or the UE 520 may be wide beams. Knowing an incident angle (angle of arrival (AoA)) of a beam being received at the RIS 530 and a reflected (or redirected) angle (angle of departure (AoD)) of a beam being reflected away from the RIS 530 is usually sufficient to properly configure the RIS 530 to allow the RIS 530 to redirect an incident signal from the BS 510 to a UE 520.

In FIG. 5B, the beams from the BS 510 and the UE 520 do not cover the entire RIS 530. A BS beam 512 resulting in a beam spot 515 on the RIS 530 and a receiver beam 522 resulting in a beam spot 525 are shown in FIG. 5B. The two beam spots 515 and 525 have some overlap, but there are also portions of each beam spot that are outside the overlap area. This may occur for a near field communication scenario, in which the beams from the BS 510 and/or UE 520 have narrow beams and/or the RIS may be large. In such a case, the beam spots from different nodes may not coincide, or even overlap, at the RIS. Consequently, even if the RIS 530 is properly configured to redirect a signal from the BS 510 to the UE 520, a gain from the RIS 530 may only result from RIS elements in a region where beam spots of the BS beam and UE beam overlap. The RIS elements in the non-overlapped region do not provide additional RIS gain. Therefore, it is of interest to configure beamforming for the BS 510 and for the UE 520 such that beams from the BS 510 and the UE 530 are mostly overlapping at the RIS 530 for a scenario such as described for FIG. 5B where not all of the RIS 530 is used. Then, with proper BS and UE beamforming and RIS configuration, the unused portion of the RIS for the scenario in FIG. 5B can be utilized to facilitate the communication of other links.

It is to be understood that when referring to the beams for communication between two nodes when using the RIS, one node is using transmit beams and the other node is using receive beams. Depending on the direction of the communication, the BS may be using a transmit beam and the UE using a receive beam (downlink (DL)), the UE may be using a transmit beam and the BS using a receive beam (uplink (UL)), a first UE may be using a transmit beam and a second UE using a receive beam (sidelink (SL)) or vice versa. The transmit beam, when activated, illuminates at least a portion of the RIS with a majority of the beam power, forming a certain area on the RIS, which is being referred to as the beam spot. For such an area of RIS elements, the RIS elements may be adjusted with certain phase information that will beamform the signal on route to the receiver. The receiver has a receive filter whose coefficients may be set assuming a certain AoA of a beam at the receiver. The beam spot for the receiver is an area on the RIS that the transmit signal would interact with on the RIS and be focused to the receiver. When there is reciprocity between the transmit and receive directions of two nodes, the receive beam of a given node for receiving from the other node should be the same as the transmit beam of the given node to transmit to the other node.

When the transmitter and the receiver are communicating with the help of the RIS, but the transmitter and/or receiver beam spots do not cover the whole RIS, there is the potential for misalignment of the transmitter beam spot and the receiver beam spot at the RIS. Misalignment of the beam spots at the RIS may degrade the performance of the communication link.

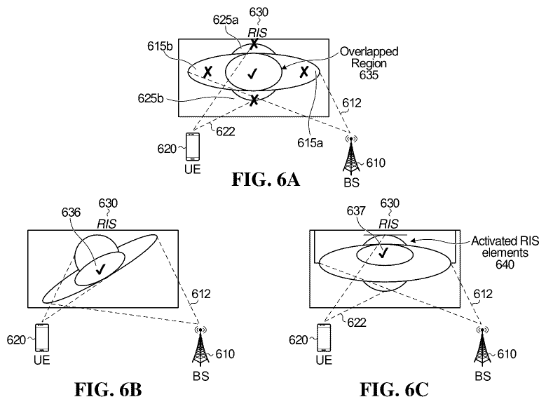

FIGS. 6A, 6B and 6C illustrate three examples of factors that affect the overlap of the beam spots and ultimately the overall gain of the signal in a communication link between a BS 610 and a UE 620 via a RIS 630. Gain resulting from the RIS 630 depends on an amount of overlapped region 635 of both the transmitter beam 612 and the receiver beam 622 as shown in FIG. 6A. Hence, even if the entire RIS 630 is configured to direct an incident signal from the starting point (i.e. the BS 610) towards the destination (i.e. the UE 620), there is no gain obtained from regions of the RIS 530 where the two beam spots from the transmitter and receiver beams do not overlap. For example, the portions of the transmit beam spot 615a and 615b and the portions of the received beam spot 625a and 625b do not overlap.

Alignment of the transmitter beam spot and the receiver beam spot at the RIS may depends on several different factors. Such factors include, but are not limited to:
1) Locations of the communication nodes and the RIS. For example, the distance and the angle between a node and the RIS affects the beam spot of that node at the RIS. As seen in FIG. 6A, the beam spot of the transmit beam 612 from the BS 610 impinging on the RIS 630 has a different shape than the beam spot of the receive beam 622 from the UE 620 impinging on the RIS 630.
2) Beamwidths at different nodes, which may also depend on an antenna array structure (e.g. rectangular, square antenna arrays, etc.), may also affect the beam spot size and shape, as can be seem in FIG. 6A.
3) Orientation of the communicating nodes and the RIS 630, as shown in FIG. 6B. For different orientations of the nodes, the beam spots resulting from the beams impinging on the RIS 630 may be different. When comparing FIGS. 6A and 6B, the transmit beam from the BS 610 in FIG. 6A is different than the transmit beam from the BS 610 in FIG. 6B and therefore the overlapped region 636 in FIG. 6A is different than that of the overlapped region 635 in FIG. 6B.
4) The portions of elements of the RIS that are configured and activated, as shown in FIG. 6C. For example, when only a particular portion 640 of the RIS 630 is configured and activated to redirect a beam 612 from the BS 610 to the UE 620, the gain of the RIS 630 depends on the elements of the RIS 630 that are configured and located in the overlapped region 637 of the beam spot of the BS 610 and the beam spot of the UE 620.

Aspects of the disclosure are provided that involve configuring the beams of different nodes so that the beam spots from the different nodes overlap such that the received signals of one or more nodes satisfy a service requirement (e.g.: a rate value, a gain value, a SNR value, or the like). Another aspect of the disclosure is providing control signaling in order to optimize the overlapping area of the beam spots, for example signaling information pertaining to one or more beam parameters is exchanged between the transmitter and the receiver in order to facilitate the beamforming that is performed at each node. The control signaling may also involve signaling between the transmitter and the RIS and/or between the receiver and the RIS to configure the RIS to activate particular portions of the RIS to redirect the beam between the transmitter and receiver.

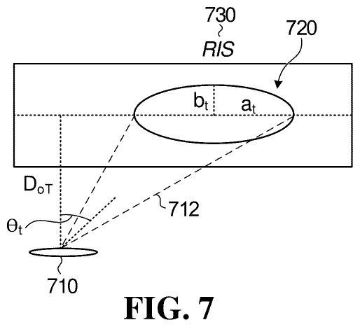

FIG. 7 illustrates an example of interaction of a beam 712 of a node 710, either a transmitter or a receiver, and a RIS 730 in the form of the beam spot 720 impinging on a portion of the RIS 730. In FIG. 7, if node 710 is a transmitter, a received signal strength of a signal reflected off of the RIS 730 at a receiver (not shown) depends on a total gain that includes a gain G_{T} at a transmitter, a gain G_{R} at the receiver, and a gain G_{RIS} at the RIS 730. Hence, that total gain expression satisfies the following formula:

$$G = {G}_{RIS} {G}_{T} {G}_{R} .$$

The gain at the transmitter G_{T} may depend on a number of antennas at the transmitter and a beamforming gain. When the beamwidth of the beam transmitted by the transmitter is expressed in terms of azimuth and elevation, for a given beamwidth, the gain may be approximated such that it satisfies the following formula:

$${G}_{T} \approx \frac{16}{sin {BW}_{a}^{T} sin {BW}_{e}^{T}} ,$$

where BWTₐ^{T} is the beamwidth at the transmitter in the azimuth direction and BWₑ^{T} is the beam width at the transmitter for the elevation direction.

The gain at the receiver G_{R} may be approximated using a similar formula to G_{T}, but by replacing BWₐ^{T} with BWₐ^{R} (beamwidth for receive beam in azimuth direction) and BWₑ^{T} with BWₑ^{R} (beamwidth for receive beam for elevation).

The gain for the RIS G_{RIS} depends proportionally on the square area of the overlapped region of the transmitter beam spot and the receiver beam spot at the RIS 730. In some embodiments, the G_{RIS} depends on the square of the number of RIS elements in the overlapped region. However, assuming the reflected signals from the RIS elements align coherently at the receiver and the RIS elements are distributed uniformly at the RIS 730, then the G_{RIS} depends proportionally on the square area of the overlapped beam spots.

One particular example of how the overlapped area of the beam spots may be obtained is described as follows with regard to variables defined in FIG. 7.

The beam spot 720 resulting from the beam 712 of the transmitter beam, when the node 710 is considered to be the transmitter, impinging on the RIS 730, or the beam of the receiver beam impinging on the RIS 730, can be determined with the help of conic sections. For example, consider the variables shown in FIG. 7, where the elliptical beam spot 720 is defined by the parameter at (long direction of beam spot 720) and bₜ (the short direction of the beam spot 720) results from the intersection of the beam 712 and the RIS 730. Assuming 1) the azimuth angle is equal to θₜ, 2) an inclination elevation angle equals 90 degrees, and 3) the same beamwidth is equal to W_{T} for both the azimuth and elevation directions, then, the beam spot parameters aₜ and bₜ can be obtained with equations satisfying the following formulas:

$${a}_{t} = 0.5 {D}_{o T} ( tan ( {θ}_{t} + 0.5 {W}_{T} ) - tan ( {θ}_{t} - 0.5 {W}_{T} ) )$$

$${b}_{t} = \frac{{D}_{o T}}{cos {θ}_{t}} tan ( 0.5 {W}_{T} ) ,$$

where DoT is a distance from the node 710 to the RIS 730 in a direction normal to the RIS 730 and θₜ is the angle of the beam with respect to the direction normal to the RIS 730.

Once the size and location of the beam spots of the transmitter beam and the receiver beam on the RIS 730 are each determined, the overlapped beam spot region can be determined from the intersection of the two respective beam spots. An example of the overlapping beam spots can be seem referring back to FIG. 6A, in which the overlapping portion of beam spot from BS beam 612 and beam spot from UE beam 626 is overlapping beam spot 635. In some embodiments, for simplicity, the overlapping area can be approximated as a smaller ellipse.

As the G_{RIS} is a result of the directly overlapped region only, configuring the transmitter beam and the receiver beam such that the respective beam spots are substantially overlapped at the RIS maximizes the G_{RIS}.

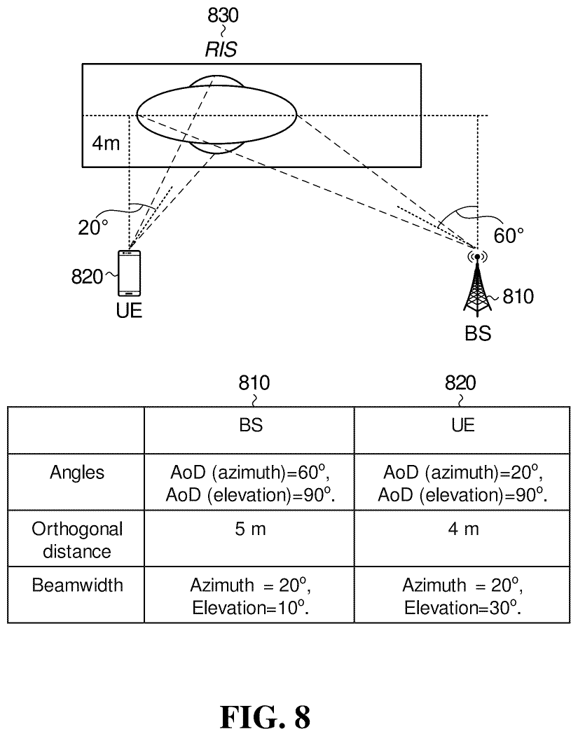

A specific example is now provided, with reference to FIG. 8, showing information related to a transmitter beam from a base station 810 and receiver beam from a UE 820 with respect to a RIS 830 for a particular set of parameters.

In the example of FIG. 8, the beams are not completely overlapped. The distance to the RIS 830 normal to the RIS 830 for the BS 810 and for the UE 820 are provided, the angles expressed in azimuth and elevation for the angle of departure from either the BS 810 and the UE 820 (which would also be the angle of arrival if the link has directional reciprocity), and the beamwidths for the BS 810 and the UE 820 are all shown in the table.

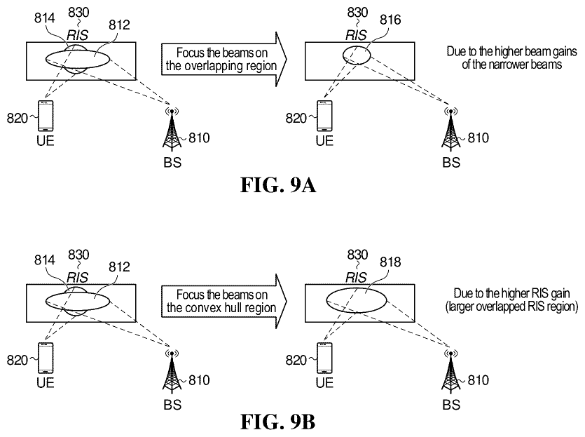

Two different solutions for optimizing the overlap of the BS beam spot from the BS 810 and the UE beam spot from the UE 820 as illustrated in FIG. 8 will now be described with reference to FIGS. 9A and 9B. Initially, prior to optimizing the beam spot overlap as shown in both FIGS. 9A and 9B, the BS beam spot 812 and the UE beam spot 814 do not substantially overlap

A first solution (as shown in FIG. 9A) involves the BS 810 and the UE 820 being reconfigured to focus their respective beams on a region of the RIS so that the beam spots of the BS and UE are beamformed to be approximately the same size, which is the size of the overlapping area 816 of the original two beam spots. In this example, the total gain of a signal transmitted in the communication link increases because the gains of the BS beam and UE beam each increase because the BS 810 and the UE 820 each use narrower beams and the BS beam and UE beam coincide and substantially overlap at the RIS 830. Based on the beam spot size and location determined for each of the BS and the UE, beamforming parameters are then determined that will result in achieving the respective beam spots on the RIS. Once the beams are configured to substantially overlap there is no gain degradation that occurred initially as a result of the beam spots being larger than the overlapped region.

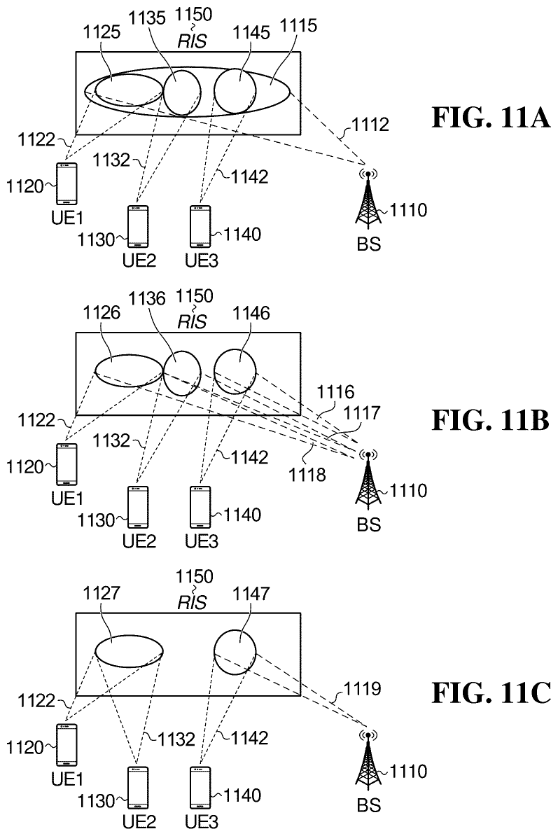

An advantage of this first solution is that such a solution is helpful when there are multiple UEs, because a non-illuminated area of the RIS, i.e. a portion of the RIS 830 not being used for the communication link, may be configured and activated to serve other UEs, as will be shown in the examples of FIG. 11.

A second solution (as shown in FIG. 9B) involves the BS 810 and the UE 820 being reconfigured to focus beams such that the beam spots of the BS beam and the UE beam cover a convex hull region 818 (i.e. a region that has the two perpendicular axis of the ellipse equal to the largest value in those respective directions of the two beams spots). In this second solution, although the beamforming gains of the BS 810 and the UE 820 may be reduced due to using reconfigured wider beams than the original beams, the RIS gain increases as the size of the overlapped region increases and therefore more RIS elements help redirect the signal transmitted by the BS 810 to the UE 820 for DL, or vice versa for UL. Based on the beam spot size and location determined for each of the BS and the UE, beamforming parameters are then determined that will result in achieving the respective beam spots on the RIS. Consequently, in this example the overall gain increases.

When compared to the first solution, the second solution may not be able to accommodate as many UEs because a larger portion of the RIS 830 is used for a single BS/UE communication link. However, in some embodiments, the second solution may have a higher reliability and robustness as compared to the first solution.

In addition to the first and second solutions described above, it should be understood that there are many other solutions in which the BS beam and UE beam may be reconfigured so that beamforming by the BS and the UE results in a BS beam spot and a UE beam spot that are substantially overlapped. Each solution may be appropriate for specific service requirements including, but not limited to:
1) total gain and signal strength thresholds,
2) reliability and robustness (e.g. in case of mobility scenarios),
3) number of UEs and/or links to be served by the RIS.

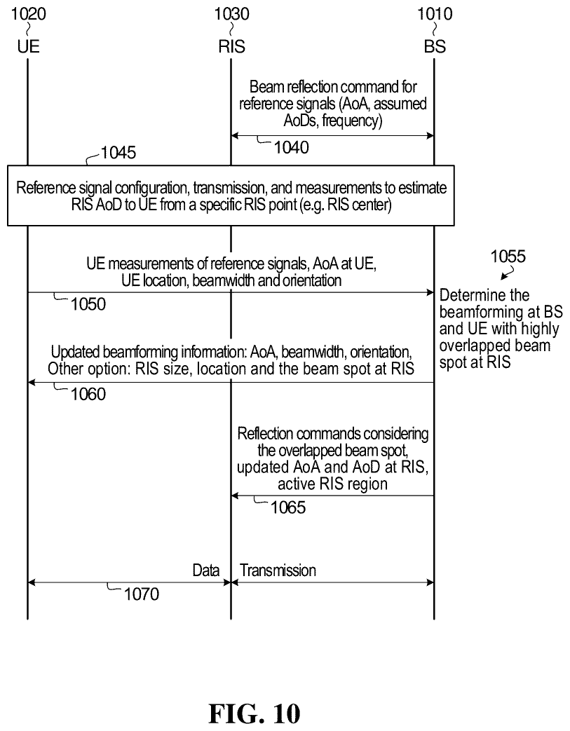

A signaling flow diagram is shown in FIG. 10 that illustrates signaling between a base station (BS) 1010, a UE 1020 and a RIS 1030 for optimizing beam spot alignment on the RIS 1030. The BS 1010, or network that the BS 1010 is part of, determines beam parameter information such as an angle of arrival (AoA) at the RIS 1030 and an angle of departure (AoD) at the RIS 1030 (in both azimuth and elevation direction as appropriate) for a beam transmitted by the BS 1010 for DL or for a beam transmitted by the UE 1010 for UL based on a threshold for a measured reference signal transmitted on a beam of the communication link. Examples of the specific threshold may be a SNR or a gain threshold of the signal being measured.

An initial step 1040 may involve the BS 1010, or the network that the BS 1010 is part of, having knowledge of the location of the BS 1010 and the location of the RIS 1030, beamforming a signal to send to the RIS 1030 that includes configuration information for the RIS 1030 to reflect reference signals transmitted by the BS 1010 in different directions, which can be measured by the UE 1020 to determine one or more of AoD from the BS 1010, AoA at the RIS 1030, or AoA at the UE 1020. An example of a reference signal being transmitted by the BS 1010 is a channel state information reference signal (CSI-RS).

Then at step 1045, signaling between the BS 1010 and UE 1020 occurs to notify the UE 1020 about configuration information pertaining to reference signals that may be sent by the BS 1010 and that may be received and measured by the UE 1020 so that the UE 1020 can feedback information to the BS 1010. The configuration information may be sent as radio resource control (RRC) signaling. After the UE 1020 is configured with the appropriate configuration information, and in combination with configuration information provided to the RIS 1030 in step 1040, the BS 1010 sends the reference signals in different directions that that will be reflected in different directions by the RIS 1030.

At step 1050, the UE 1020, while beam sweeping, performs measurements (e.g. reference signal received power (RSRP), SNR, received signal strength indicator (RSSI), . . . etc.) of the received reference signals that were identified by the BS 1010 in the configuration information in step 1045. The UE 1020 also feeds back information to the BS 1010 regarding the measure signals in step 1050. The UE 1020 may receive commands from the BS 1010 about the feedback information needed by the BS 1010. In some embodiments, the feedback information may include an index of one or more reference signals for which a measured signal meets a threshold (e.g., the SNR is greater or equal a specific value). In some embodiments, the feedback information may include an indication of an AoA (including both azimuth and elevation directions) at the UE 1020. Such indication may for example specify the AoA with respect to a reference point and/or direction. The reference point may, for example, refer to a known location of a nearby obstacles like a door, pillar, or window, while the reference direction may, for example, refer to a global direction (e.g., north). In some embodiments, the feedback information may include a location of the UE 1020. The location of the UE 1020 may be determined by sensing methods and/or GPS localization. In some embodiments, the feedback information may include beam parameter information such as a beamwidth used for a received beam and/or an orientation of the UE 1020. The orientation of the UE 1020 may be expressed with respect to a reference point or direction (e.g., north), wherein the reference point or direction is known to the BS 1010 and/or network the BS 1010 is a part of.

In some embodiments, the feedback information may include a number of antennas at the UE 1020 and/or an antenna array pattern at the UE 1020.

From the measurements performed in step 1050 and the feedback information transmitted to the BS 1010, the BS 1010, or the network that the BS 1010 is a part of, determines 1055 the beam spot size and location on the RIS 1030 for the BS beam and for the UE beam. At step 1055, the BS 1010 may also estimate a desired AoD from the RIS 1030 to the UE 1020.

The BS 1010 sends, at step 1060, updated beamforming configuration information to the UE 1020 to configure the UE 1020 to beamform the beam, which when used in conjunction with the beamforming information, also determined by the BS 1010, to beamform the BS beam, aligns the beam spots of the BS beam and UE beam at the RIS 1030. The updated beamforming configuration information may update beam directions and beamwidths for use by the UE 1020. The updated beamforming configuration information may also include one or more of an AoD for a beam transmitted by the BS 1010 and the associated beamwidth, an AoA for a beam arriving at the UE 1020 and the associated beamwidth, and incident and redirected angles at the RIS 1030. In comparison, and as an example, in step 1045, the BS AoD for reference signals may be directed towards the center of the RIS 1030, but after receiving feedback from the UE 1020, at step 1060 the BS 1010 may choose to direct a beam to the right or left side of the RIS 1030, and configure beamforming for the UE 1020 accordingly.

The updated beamforming information may include a location and an area where an overlapping beam spot occurs at the RIS 1030. Using this information, the location of the UE 1020, and a number of antennas and antenna array pattern of the UE 1020, the UE 1020 can beamform a beam (width and direction) such that the beam spot at the RIS 1030 covers a suggested area for the overlap to occur.

The updated beamforming information may include updated AoA and the beamwidth at the UE 1020. When the BS 1010 is provided the feedback information from step 1050, and knows the location, size, orientation of the RIS 1030, the BS 1010 can send 1060 the beamforming configuration information to the UE 1020 to enable the UE 1020 to configure beamforming at the UE 1020 (e.g. direction and beam-width) such that the total gain from BS 1010, UE 1020, and RIS 1030, achieves a specific threshold (e.g. SNR threshold, RSRP threshold, . . . ).

At step 1060, the BS 1010 may also send RIS configuration information to notify the UE 1020 about information pertaining to the RIS 1030 that the UE 1020 should be made aware.

At step 1065, the BS (or the network) sends RIS configuration information to the RIS 1030. The RIS configuration information may be used to configure an appropriate portion of the RIS 1030 to redirect a signal between the BS 1010 and UE 1020 in which the BS beam spot and the UE beam spot are highly overlapped. In some embodiments, the total gain from the BS 1010, the UE 1020 and the RIS 1030 satisfies a specific threshold. The RIS configuration information may include information to configure the RIS 1030 that has been determined based on determinations made by the BS 1010 at step 1055, such as the overlapped beam spot size and location, updated AoA and AoD at RIS and the active region for the RIS 1030. In some embodiments, the BS, or network, may configure the RIS 1030 with the RIS configuration information via narrow beams to increase the gain or via wide beams to increase the reliability and robustness.

Steps 1060 and 1065 are shown in a particular order in FIG. 10, it should be understood that these two steps may occur in the opposite order, or substantially simultaneously,

With the configured beamforming at the BS 1010, the UE 1020, and the RIS 1030, the BS 1010 and UE 1020 can start communicating over the configured link, for example exchanging additional control information or data.

In some embodiments, the RIS 1030 has active receive and/or transmit elements that can receive and measure signals and/or transmit signals, as opposed to only redirect signals. When the RIS 1030 has such active receive and/or transmit elements, the RIS 1030 may perform measurements of the reference signals transmitted by the BS 1010 and/or the UE 1020 or send reference signals which are then measured by the BS 1010 and/or the UE 1020.

While the method described above is based on the BS 1010 transmitting reference signals and the UE performing measurement and feeding back, it is to be understood that a similar method may be performed in which the UE 1020 transmits reference signals, such as sounding reference signals (SRS) and the BS 1010 performs measurements. Such a scenario may occur in the UL direction. After performing the measurements of the received SRSs, the BS can determine information such as the BS AoA (corresponding to one or more RS received with good strength) and information related to the RIS such as the AoA at the RIS. Then, the BS may send feedback information to the UE regarding the measurements (e.g. the index of one or more beams that are received with acceptable strength (i.e., satisfying a certain threshold of SNR, RSSI, RSRP, . . . )). Then, the UE may feedback the AoD associated with indices of the one or more beams. As in DL, the UE may also send one or more of the following: UE location, number of antennas, antenna array patterns; UE beam shape and beamwidth; and orientation of the UE with respect to a reference point. After that, given the feedback information and the BS measurements, the BS may determine the new configuration information to align the beam spots at the RIS from the BS and UE by updating beam directions and beamwidths for both the BS and the UE and the redirection commands for the RIS.

The measurements by the UE (e.g. measurements can be one or more of the following: RSs strength (SNR, RSSI, . . . ), beam index, UE AoA in DL, AoD in UL, UE orientation, UE location) may be sent back to the BS (or another network equipment) via an uplink control channel such as physical uplink control channel (PUCCH), physical uplink shared channel (PUSCH), or another uplink channel. One the other hand, the BS (or another network equipment) may send its measurements (e.g. RSs measurements) and come configuration (e.g. updated beam directions and beam-width at the UE) to a UE through a DL channel such as physical downlink control channel (PDCCH), MAC (media access control or medium access control) signaling, or other DL signaling. Moreover, The BS (or another network equipment) may use RRC signaling for configuration like: configure a UE for reference signaling (e.g. CSI-RS in DL or SRS in UL), the RIS redirection commands, and other configurations for beam directions and beamwidths for different nodes, beam spots at the RIS, RIS location and size, beam shape, antenna array pattern, number of antennas and other may be communicated through RRC signaling or UE category information for example.

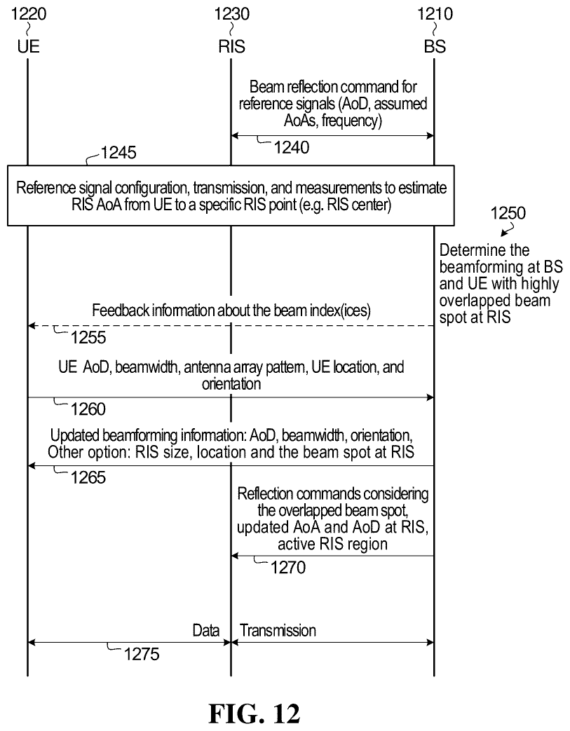

A signaling flow diagram is shown in FIG. 12 that illustrates signaling between a BS 1210, a UE 1220 and a RIS 1230 for optimizing beam spot alignment on the RIS 1230. The BS 1210, or network that the BS 1210 is part of, determines beam parameter information such as an angle of arrival (AoA) at the RIS 1230 and an angle of departure (AoD) at the RIS 1230 (in both azimuth and elevation direction as appropriate) for a beam transmitted by the BS 1010 for DL or for a beam transmitted by the UE 1010 for UL based on a threshold for a measured reference signal transmitted on a beam of the communication link. Examples of the specific threshold may be a SNR or a gain threshold of the signal being measured.

An initial step 1240 may involve the BS 1210, or the network that the BS 1210 is part of, having knowledge of the location of the BS 1210 and the location of the RIS 1230, beamforming a signal to send to the RIS 1230 that includes configuration information for the RIS 1230 to reflect reference signals transmitted by the UE 1220 in different directions, which can be received by the BS 1210 to determine one or more of AoD from the UE 1220, AoA at the RIS 1230, or AoA at the BS 1210. An example of a reference signal being transmitted by the UE 1220 is a SRS.

Then at step 1245, signaling between the BS 1210 and UE 1220 occurs to notify the UE 1220 about configuration information pertaining to reference signals that may be sent by the UE 1220 and that may be received and measured by the BS 1210 so that the BS 1210 can determine 1250 beamforming at the BS 1210 and UE 1220 for an appropriately overlapped beam spot at the RIS 1230. The configuration information may be sent as RRC signaling.

After the BS 1210 determines appropriate beamforming configuration information, and in combination with configuration information provided to the RIS 1230 in step 1240, the BS 1210 may optionally (as indicated by the dashed line) send 1255 the beamform configuration information to the UE 1220. This may take the form of the BS 1210 indicating indices of beams that can be used by the UE 1220 for transmitting to the BS 1210 via the RIS 1230. The indices of the beams may be with reference to a reference point or reference direction.

The UE 1220 may optionally (as indicated by the dashed line) send 1255 additional information about the UE 1220 to the BS 1210. For example UE AOD, beamwidth of transmit beam, UE antenna array pattern, UE location and UE orientation. If the BS 1210 is aware of this information it would not need to be provided by the UE 1220. The UE 1220 may receive commands from the BS 1010 about the feedback information needed by the BS 1210.

The BS 1210 sends, at step 1265, updated beamforming configuration information to the UE 1220 to configure the UE 1220 to beamform the beam, which when used in conjunction with the beamforming information, also determined by the BS 1210, to beamform the UE beam, aligns the beam spots of the BS beam and UE beam at the RIS 1230. The updated beamforming configuration information may update beam directions and beamwidths for use by the UE 1020. The updated beamforming configuration information may also include one or more of an AoD for a beam transmitted by the UE 1220 and the associated beamwidth, an AoD for a beam arriving at the BS 1220 and the associated beamwidth, and incident and redirected angles at the RIS 1030. In comparison, and as an example, in step 1245, the UE AoD for reference signals may be directed towards the center of the RIS 1230, but after receiving updated configuration from the BS 1210, at step 1265 the UE 1220 may choose to direct a beam to the right or left side of the RIS 1230.

The updated beamforming information may include a location and an area where an overlapping beam spot occurs at the RIS 1230. Using this information, the location of the UE 1220, and a number of antennas and antenna array pattern of the UE 1220, the UE 1220 can beamform a beam (width and direction) such that the beam spot at the RIS 1230 covers a suggested area for the overlap to occur.

The updated beamforming information may include updated AoD and the beamwidth at the UE 1220. When the BS 1210 knows the location, size, orientation of the RIS 1230, the BS 1210 can send 1265 the beamforming configuration information to the UE 1220 to enable the UE 1220 to configure beamforming at the UE 1220 (e.g. direction and beam-width) such that the total gain from BS 1210, UE 1220, and RIS 1230, achieves a specific threshold (e.g. SNR threshold, RSRP threshold, . . . ).

At step 1265, the BS 1210 may also send RIS configuration information to notify the UE 1220 about information pertaining to the RIS that the UE 1220 should be made aware.

At step 1070, the BS 1210 (or the network) sends RIS configuration information to the RIS 1230. The RIS configuration information may be used to configure an appropriate portion of the RIS 1230 to redirect a signal between the BS 1210 and UE 1220 in which the BS beam spot and the UE beam spot are highly overlapped. In some embodiments, the total gain from the BS 1210, the UE 1220 and the RIS 1230 satisfies a specific threshold. The RIS configuration information may include information to configure the RIS 1230 that has been determined based on determinations made by the BS 1210 at step 1250, such as the overlapped beam spot size and location, updated AoA and AoD at the RIS 1220 and the active region for the RIS 1230. In some embodiments, the BS 1210, or network, may configure the RIS 1230 with the RIS configuration information via narrow beams to increase the gain or via wide beams to increase the reliability and robustness.

With the configured beamforming at the BS 1210, the UE 1220, and the RIS 1230, the BS 1210 and UE 1220 can start communicating over the configured link, for example exchanging additional control information or data.

In some embodiments, the RIS 1230 has active receive and/or transmit elements that can receive and measure signals and/or transmit signals, as opposed to only redirect signals. When the RIS 1230 has such active receive and/or transmit elements, the RIS 1230 may perform measurements of the reference signals transmitted by the BS 1210 and/or the UE 1220 or send reference signals which are then measured by the BS 1210 and/or the UE 1220.

In addition to the single transmitter-receiver pair described in the examples above, it is possible to extend the proposed solution for multi-transmitter and/or multi-receiver transmission scenarios. Such scenarios include, but are not limited to, those shown in FIGS. 11A, 11B and 11C.

FIG. 11A is directed to a broadcast transmission scenario. In this scenario, the BS 1110 sends common information to multiple UEs UE1 1120, UE2 1130 and UE3 1140. The BS 1110 may transmit via a wide beam 1112 that has a large beam spot 1115 on the RIS 1150. The RIS 1150 is configured such that different RIS portions within the BS beam spot 1115 redirect the incident signal towards different UEs, UE1 1120, UE2 1130 and UE3 1140. For example, UE1 1120 has a beam spot 1125 that is within a portion of the BS beam spot 1115, UE2 1130 has a beam spot 1135 that is within a portion of the BS beam spot 1115 and UE3 1140 has a beam spot 1145 that is within a portion of the BS beam spot 1115. None of the beam spots 1125, 1135 and 1145 overlap with one another and so the respective portions of the RIS are configured to redirect the BS signal towards one of the three UEs.

FIG. 11B is directed to a private information multi-user transmission scenario. In this scenario, the BS 1110 sends private information to each one of multiple UEs UE1 1120, UE2 1130 and UE3 1140. Then, the BS 1110, using multiple antenna panels may transmit different signals via multiple BS antenna panels. The signal sent by each BS antenna panel has a different beam spot 1126, 1136, 1146 at the RIS 1150. The RIS 1150 is configured such that different portions of the RIS 1150 covered by different beam spots each redirect the incident signal towards different UEs UE1 1120, UE2 1130 and UE3 1140. For example, UE1 1120 has a beam spot 1126 that substantially overlaps with a first BS beam spot from BS beam 1118, UE2 1130 has a beam spot 1136 that substantially overlaps with a second BS beam spot from BS beam 1117 and UE3 1140 has a beam spot 1145 that substantially overlaps with a third BS beam spot from BS beam 1116. The beam of each UE UE1 1120, UE2 1130 and UE3 1140 is configured such that it fully or mostly covers the region of the RIS 1150 that is configured to redirect a signal toward. In some embodiments, a single panel may be used by the BS 1110 in conjunction with a TDM approach where different UEs are served by the single panel at different times.

FIG. 11C is directed to combinations of uplink, downlink and/or side-link communication scenarios. This scenario includes two or more separate links being facilitated by the same RIS 1150. For example, via the same RIS 1150, the BS 1110 can communicate with UE3 1140 (e.g. UL or DL) using a first portion of the RIS 1150 and using a second portion of the RIS 1150, UE1 1120 and UE2 1130 may communicate with each other (e.g. SL). FIG. 11C shows the overlapping beam spot 1147 of the BS beam 1119 and the UE3 beam 1142 and the overlapping beam spot 1127 of the UE1 beam 1122 and the UE2 beam 1132.

The SL communication shown in FIG. 11C is controlled by the BS 1110. Two example methods are described below for how the UEs are controlled. In both cases UE1 1120 is considered to be the transmit UE and UE2 1130 is considered to be the receive UE.

In the first method, the BS 1110 determines the beam spot of each UE separately in a similar manner as would be performed for UE3 1140, which involves the UEs 1120 and 1130 sending feedback information to the BS 1110 so the BS can determine beamforming configuration information to send to the UEs 1120 and 1130. Then the BS 1110 sends the beamforming configuration information to each of the two UEs 1120 and 1130 that will enable improved overlap of beam spots for the beams of UE1 1120 and UE2 1130 on the RIS 1150 for transmitting or receiving signals between UE1 1120 and UE2 1130. The beamforming configuration information may include one or more of an AoA for the receive beam of UE2 1130 that is determined by the BS 1110, an AoD for the transmit beam of UE1 1120 that is determined by the BS 1110, the beamwidth of the transmit beam of UE1 1120 or a receive beam of UE2 1130, and a size of the RIS 1150.

In the second method, the BS 1110 sends configuration information notifying the UEs 1120 and 1130 about relevant information of the RSs and beam parameter information to be used by UE1 1120 and UE2 1130. Examples of RSs to be transmitted by UE1 1120 may be, for example, SRS. Then UE1 1120 sends RSs via different beams. The RIS 1150 redirects the RSS assuming different incident and redirected directions. UE2 1130 receives the RSs and measures their strengths.

UE1 1120 and UE2 1130 may then send indices identifying one or more particular beams that satisfy a certain threshold (for example SNR) and the corresponding directions of the beams (e.g. AoD from UE1 and AoA from UE2) with respect to a reference point. In some embodiments, the UE1 1120 and UE2 1130 may send other measurement information based on measurements made at the UEs. Then, the BS 1110 may send beam parameter configuration information that may include one or more of an AoA for the receive beam of UE2 1130 that is determined by the BS 1110, an AoD for the transmit beam of UE1 1120 that is determined by the BS 1110, the beamwidth of the transmit beam of UE1 1120 or a receive beam of UE2 1130, and a size of the RIS 1150.

The RIS 1150 and the UEs 1120, 1130 and 1140 may be configured to operate as in any of FIGS. 11A, 11B and 11C, using a method such as that described above with regard to FIG. 10.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method at a side of a user equipment (UE), comprising:
receiving first configuration information, the first configuration information comprising information for improved overlap of a first beam spot of a first beam of a base station (BS) and a second beam spot of a second beam of the UE, the first beam spot and the second beam spot both impinging on a reconfigurable intelligent surface (RIS) for transmitting or receiving signals between the base station and the UE; and
reconfiguring the UE based on the first configuration information.

2. The method of claim 1, further comprising:
receiving second configuration information, the second configuration information comprising first identification of a plurality of beams, each beam of the plurality of beams having an associated direction, the second configuration information further comprising second identification of reference signals (RSs) on the plurality of beams;
receiving the RSs on the plurality of beams;
measuring the RSs to determine an angle of arrival (AoA) of each RS in the RSs at the UE; and
transmitting measurement feedback information, the measurement feedback information comprising measurement information pertaining to a channel on a link between the base station and the UE via redirection by the RIS or a channel on a link between the RIS and the UE.

3. The method of claim 2, wherein the measurement feedback information comprises one or more of:
measurement information based on measurements made at the UE; or
the AoA of the each RS at the UE with respect to a reference point or a direction.

4. The method of claim 2, further comprising:
receiving data that has been redirected by the RIS or transmitting data to be redirected by the RIS based on the second configuration information.

5. The method of claim 1, further comprising transmitting at least one of:
UE location information;
a number of antennas used by the UE;
an antenna array pattern of the UE;
a shape of a UE beam impinging on the RIS;
beamwidth of a transmit beam or a receive beam of the UE; or
an orientation of the UE with respect to a reference point.

6. The method of claim 1, wherein the first configuration information comprises one or more of:
an AoA for a UE receive beam with respect to a reference point or a direction that is determined by the base station;
beamwidth of a transmit beam or a receive beam of the UE;
a size of the RIS;
a location of an overlapping beam spot on the RIS; or
a size of the overlapping beam spot on the RIS.

7. The method of claim 6, wherein the first configuration information comprises configuration information that enables the UE to interact with the base station by identifying:
a portion of the RIS that is used for broadcast communication with at least two different UEs; or
different portions of the RIS that are used for UE specific communication with each of multiple UEs.

8. A device at a side of a user equipment (UE), comprising:
at least one processor; and
a computer-readable medium having stored thereon, computer executable instructions, that when executed by the at least one processor, cause the device to perform operations including:
receiving first configuration information, the first configuration information comprising information for improved overlap of a first beam spot of a first beam of a base station (BS) and a second beam spot of a second beam of the UE, the first beam spot and the second beam spot both impinging on a reconfigurable intelligent surface (RIS) for transmitting or receiving signals between the base station and the UE; and
reconfiguring the UE based on the first configuration information.

9. The device of claim 8, wherein the operations further includes:
receiving second configuration information, the second configuration information comprising first identification of a plurality of beams, each beam of the plurality of beams having an associated direction, the second configuration information further comprising second identification of reference signals (RSs) on the plurality of beams;
receiving the RSs on the plurality of beams;
measuring the RSs to determine an angle of arrival (AoA) of each RS in the RSs at the UE; and
transmitting measurement feedback information, the measurement feedback information comprising measurement information pertaining to a channel on a link between the base station and the UE via redirection by the RIS or a channel on a link between the RIS and the UE.

10. The device of claim 9, wherein the measurement feedback information comprises one or more of:
measurement information based on measurements made at the UE; or
the AoA of the each RS at the UE with respect to a reference point or a direction.

11. The device of claim 9, wherein the operations further include:
receiving data that has been redirected by the RIS or transmitting data to be redirected by the RIS based on the second configuration information.

12. The device of claim 8, wherein the operations further includes: transmitting at least one of:
UE location information;
a number of antennas used by the UE;
an antenna array pattern of the UE;
a shape of a UE beam impinging on the RIS;
beamwidth of a transmit beam or a receive beam of the UE; or
an orientation of the UE with respect to a reference point.

13. The device of claim 8, wherein the first configuration information comprises one or more of:
an AoA for a UE receive beam with respect to a reference point or a direction that is determined by the base station;
beamwidth of a transmit beam or a receive beam of the UE;
a size of the RIS;
a location of an overlapping beam spot on the RIS; or
a size of the overlapping beam spot on the RIS.

14. The device of claim 13, wherein the first configuration information comprises configuration information that enables the UE to interact with the base station by identifying:
a portion of the RIS that is used for broadcast communication with at least two different UEs; or
different portions of the RIS that are used for UE specific communication with each of multiple UEs.

15. A method at a side of a base station, comprising
transmitting first configuration information, the first configuration information comprising information relevant to a user equipment (UE) for improved overlap of a first beam spot of a first beam of the base station and a second beam spot of a second beam of the UE, the first beam spot and the second beam spot both impinging on a reconfigurable intelligent surface (RIS); and
transmitting second configuration information, the second configuration information comprising configuration information relevant to the RIS for the improved overlap of the first beam spot of the base station and the second beam spot of the UE on the RIS.

16. The method of claim 15, further comprising:
transmitting data that is redirected by the RIS or receiving data to be redirected by the RIS based on the first configuration information and second configuration information.

17. The method of claim 15, further comprising:
transmitting third configuration information, the third configuration information comprising first identification of a plurality of beams, each beam of the plurality of beams having an associated direction, the third configuration information comprising second identification of reference signals (RSs) on the plurality of beams;
transmitting the RSs on the plurality of beams;
receiving measurement feedback information, the measurement feedback information comprising measurement information pertaining to a channel on a link between the base station and the UE via redirection by the RIS or a channel on a link between the RIS and the base station; and
determining revised configuration information for the improved overlap of the first beam spot of the base station and the second beam spot of the UE on the RIS.

18. A device at a side of a base station, comprising:
at least one processor; and
a computer-readable medium having stored thereon, computer executable instructions, that when executed by the at least one processor, cause the device to perform operations including:
transmitting first configuration information, the first configuration information comprising information relevant to a user equipment (UE) for improved overlap of a first beam spot of a first beam of the base station and a second beam spot of a second beam of the UE, the first beam spot and the second beam spot both impinging on a reconfigurable intelligent surface (RIS); and
transmitting second configuration information, the second configuration information comprising configuration information relevant to the RIS for the improved overlap of the first beam spot of the base station and the second beam spot of the UE on the RIS.

19. The device of claim 18, wherein the operations further include:
transmitting data that is redirected by the RIS or receiving data to be redirected by the RIS based on the first configuration information and second configuration information.

20. The device of claim 18, wherein the operations further include:
transmitting third configuration information, the third configuration information comprising first identification of a plurality of beams, each beam of the plurality of beams having an associated direction, the third configuration information comprising second identification of reference signals (RSs) on the plurality of beams;
transmitting the RSs on the plurality of beams;
receiving measurement feedback information, the measurement feedback information comprising measurement information pertaining to a channel on a link between the base station and the UE via redirection by the RIS or a channel on a link between the RIS and the base station; and
determining revised configuration information for the improved overlap of the first beam spot of the base station and the second beam spot of the UE on the RIS.
